(19) United States
(12) Patent Application Publication
(10) Pub. No.: US 2016/0248132 A1
(43) Pub. Date: Aug. 25, 2016

(54) HEAT STORAGE SYSTEM COMPRISING A HIGH-TEMPERATURE BATTERY

(71) Applicant: SIEMENS AKTIENGESELLSCHAFT, München (DE)

(72) Inventors: Michael Kühne, Fürth (DE); Wolfgang Menapace, Erlangen (DE); Nicolas Vortmeyer, Erlangen (DE)

(73) Assignee: Siemens Aktiengesellschaft, Munich (DE)

(21) Appl. No.: 15/031,376

(22) PCT Filed: Oct. 23, 2014
(86) PCT No.: PCT/EP2014/072705

§ 371 Date: Apr. 22, 2016

(30) Foreign Application Priority Data
Oct. 30, 2013 (DE) 10 2013 222 070.7

(51) Int. Cl. H01M 10/659; H01M 10/6552; H01M 10/627; H01M 10/6567; H01M 10/05; H01M 10/617

(52) U.S. Cl. CPC H01M 10/659; H01M 10/05; H01M 10/617; H01M 10/627; H01M 10/6567; H01M 10/6552; H01M 2220/10

(57) ABSTRACT

A heat storage system has a high-temperature battery having a plurality of storage cells, which have an operating temperature of at least 100° C., and which are in contact with a heat exchanger liquid for supplying and dissipating heat, wherein a first heat store having a heat store fluid is furthermore included, the heat store being thermally connected to the high-temperature battery in such a way that heat can be transferred from the high-temperature battery to the heat store fluid. The heat store itself is thermally connected to a low-temperature heat store for heat transfer, the low-temperature heat store being provided for storing low-temperature heat at a temperature level of at least 40° C.

### CROSS REFERENCE TO RELATED APPLICATIONS

This application is the US National Stage of International Application No. PCT/EP2014/072705 filed Oct. 23, 2014, and claims the benefit thereof. The International Application claims the benefit of German Application No. DE 102013222070.7 filed Oct. 30, 2013. All of the applications are incorporated by reference herein in their entirety.

### FIELD OF INVENTION

The present invention relates to a heat storage system comprising a high-temperature battery having a plurality of storage cells, which have an operating temperature of at least 100° C. and are in contact with a heat exchanger liquid for supplying and removing heat. Furthermore, the invention relates to a method for operating such a heat storage system.

### BACKGROUND OF INVENTION

With the increasing expansion of regenerative energy sources for providing electrical energy, an accompanying increase in decentralized storage solutions is considered to be necessary by various technical parties. Such stores are to contribute to improving the quality of the current supplied by means of the electrical power supply networks, and also to evening out the electricity supply. Suitable stores are to be suitable in particular for absorbing an excess supply of electrical energy in the power supply networks and temporarily storing it temporally for hours, to be able to supply it back to the power supply networks at a later point in time, at which an increased demand exists.

A use of high-temperature batteries, which are provided, for example, according to the invention, is distinguished by a number of positive properties (high energy storage densities, high cycle charge numbers, etc.), which make them particularly suitable for storing electrical energy from power supply networks. However, high-temperature batteries have the disadvantage of increased waste heat production, which contributes to strong exergetic heat losses because of the operating temperature, which is significantly above the ambient temperature level. However, at the same time, high-temperature batteries have to be kept at a high operating temperature level, to be able to ensure operational readiness at all. In this case, it is necessary in particular to substantially avoid variations in the operating temperature, for example, to avoid a harmful influence on the battery properties and operating properties. Thus, for example, temperature variations can cause not only permanent chemical changes in the storage cells of the high-temperature battery, which results in reduced operational readiness, but rather temperature variations can also result, for example, in damage to functional components, such as tension cracks in an ion-conducting separator (electrolytes), which can be accompanied in the worst case by the destruction of a storage cell of the high-temperature battery.

Conventional heat storage systems use a heat exchange with the surroundings, which is typically driven by convection, to bring about a temperature equalization. Thus, for example, the storage cells of such high-temperature batteries are surrounded by air, to thus be able to ensure a suitable heat exchange with the surroundings. To achieve improved temperature control of the storage cells, for example, a flow can also be applied to the air by a fan, to be able to supply heat to or dissipate heat from the high-temperature battery in a targeted manner. Since the heat supply by means of heated air to the storage cells of a high-temperature battery is usually possible only inadequately because of a lack of heat transfer performance, suitable heating devices are sometimes also integrated in high-temperature batteries, for example, to be able to keep them at a suitable operating temperature. In contrast, if heat dissipation is required, a convective heat transfer to the surroundings by means of air can fundamentally be possible at low operating temperatures. However, it is nonetheless also shown at these temperatures that strong temperature variations can still occur due to the large quantities of heat to be dissipated, which sometimes vary strongly.

In addition, it has been shown to be disadvantageous that thermal energy dissipated in this manner is lost for further processes in the normal case. Thus, for example, the heat transferred to the surrounding air is not provided for further use, whereby the overall efficiency during operation of the high-temperature battery becomes disadvantageous. However, even if this heat could be provided for further uses, it has been shown that the point in time of the occurrence of heat normally does not correspond to the point in time at which, for example, the occurring heat could be in demand as useful heat. Thus, for example, high-temperature batteries which are based on the technology of sodium-nickel-chloride cells (NaNiCl₂ cells) generate thermal energy in particular at the times of the discharge. The discharge of the high-temperature batteries typically takes place, however, only over a period of time of several minutes to a few hours. A continuous heat supply directly from this heat source is thus not possible, above all not when thermal energy is strongly in demand. This demand for heat may change in the course of a day, and also in seasonal cross section, but it is substantially independent of the demand for electrical energy from the electrical power supply networks.

### SUMMARY OF INVENTION

The objects on which the present invention is based are thus to be that of avoiding the disadvantages known from the prior art. In particular, it has proven to be technically desirable to achieve a significant efficiency improvement during operation of a heat storage system. In this case, the efficiency improvement is preferably to relate to the overall operation of the high-temperature battery, i.e., both the charging operation and also the discharging operation. Furthermore, the present invention is to enable the disadvantages known from the prior art with respect to the heat supply to and also heat dissipation from the high-temperature battery to be avoided. Furthermore, it is desirable to ensure extensive consistency of the operating temperature of the high-temperature battery, so that the high-temperature battery can be operated reliably in a temperature range having comparatively narrow breadth or variation. A typical variation width is in this case at approximately 20° C., advantageously approximately 10° C. Therefore, not only can the operating efficiency be improved, but rather also the susceptibility to malfunction and maintenance of the storage cells of the high-temperature battery can be advantageously influenced.

According to the invention, these fundamental objects are achieved by a heat storage system and by a method for operating such a storage system, as described hereafter, according to the claims.

In particular, the objects on which the invention is based are achieved by a heat storage system, comprising a high-temperature battery having a plurality of storage cells, which have an operating temperature of at least 100° C., and which are in contact with a heat exchanger liquid for heat supply and dissipation, wherein furthermore a first heat store having a heat store liquid is comprised, which is thermally interconnected with the high-temperature battery such that heat can be transferred from the high-temperature battery to the heat store fluid, and wherein the heat store is itself thermally interconnected with a low-temperature heat store for heat transfer, which is provided for storing low-temperature heat at a temperature level of at least 40° C.

Furthermore, the objects on which the invention is based are achieved in particular by a method for operating such a heat storage system, as described above and also hereafter, which comprises the following steps: —operating the high-temperature battery while generating heat; —transferring at least a part of this heat to the heat exchanger liquid; —storing at least a part of this heat by means of a heat store fluid in a heat store; —transferring at least a part of this heat to the low-temperature heat store.

The high-temperature battery according to the invention typically comprises a plurality of storage cells, which are electrically interconnected with one another in a shared housing to form a high-temperature battery. The storage cells of the high-temperature battery are in thermal contact with the heat exchanger liquid, which ensures heat supply or dissipation. The storage cells have a predetermined operating temperature, which is at least 100° C. According to the embodiment, the high-temperature batteries also have a maximum operating temperature of approximately 500° C. Accordingly, the high-temperature batteries according to the invention relate in particular to the technology of sodium-nickel-chloride cells, and also sodium-sulfur cells (NaS cells), as well as all storage technologies related thereto.

Depending on the operating mode, the storage cells can dissipate heat, or have to be supplied with heat, for example, to reach an operating temperature. Thus, for example, high-temperature batteries which are based on the technology of sodium-nickel-chloride cells have to reach at least a temperature level of approximately 250° C., to be able to keep the internal cell resistance, which is dependent on the temperature, sufficiently low. This is because the separators (typically solid-state separators) comprised by the storage cells first become sufficiently strongly ion-conductive upon reaching a sufficiently high temperature level, so that internal-cell ion flows enable battery operation.

At this point, it is to be noted that the heat supply of the high-temperature battery according to the invention comprises both the supply with thermal energy from the heat exchanger liquid to the storage cells and also the transfer of thermal energy from the storage cells to the heat exchanger liquid. Heat is thus to be understood in the present case in its general form. The concept of heat can thus comprise both positive thermal energy and also negative thermal energy (cold).

Because of the decoupling according to the invention of heat from the storage cells of the high-temperature battery by means of the heat exchanger liquid and the subsequent transfer of this heat to the low-temperature heat store, the heat can be reached suitably for all forms of low-temperature heat utilization. In particular, this heat is suitable for household or also industrial service water preparation, for building heating, for passenger compartment heating for public transit, for fuel heating or fuel drying, for example, in power plants, or also for keeping warm in the case of diesel generator sets, etc.

It is also to be expressly noted at this point that the concept of the low-temperature heat relates to heat at a temperature level between 40° C. and 200° C. Heat at this temperature level is particularly suitable for being used in applications for cogeneration. The overall efficiency of the heat storage system rises as a result of this more extensive use.

The low-temperature heat store thus does not permit storage of heat at a temperature level of greater than 200° C., whereby the exergetic heat losses to the environment can advantageously also be kept low. This is because, in particular in the case of temperatures stores at temperatures which are higher than 200° C., high heat losses to the surroundings are to be expected, which can negatively impair the overall efficiency of the heat storage system.

The direct heat exchange between high-temperature battery and heat exchanger liquid additionally has the advantage of being able to compensate better for temperature variations at an operating temperature level of the high-temperature battery, since such a liquid has an increased heat capacity and improved heat conduction in comparison to a gas. Thus, for example, a heat exchanger liquid can also readily dissipate an increased amount of heat temporarily from the high-temperature battery in the event of heat peaks and absorb it in the heat exchanger liquid, than would be possible, for example, for a gas. A suitable operating temperature level within a predefined temperature range can be set in a controlled manner by the transfer of the heat thus absorbed further to the heat store fluid. In other words, the temperature distribution in the high-temperature battery is improved uniformly. The setting can be performed in a controlled or regulated manner. The heat which is released during operation of the high-temperature battery is thus temporarily stored in the heat store by means of the heat store fluid, before this heat is again transferred by suitable decoupling to the low-temperature heat store. This transfer advantageously makes useful the heat taken from the high-temperature battery. Due to the temporary storage of the heat in the low-temperature heat store, the heat can also be removed at points in time at which an increased demand for heat exists, without, in contrast, changing the operating state of the high-temperature battery.

According to the embodiment, the heat transfer from the high-temperature battery to the heat store fluid can occur directly. Accordingly, the heat exchanger liquid is identical to the heat store fluid, for example. However, the heat transfer can also occur indirectly, so that, for example, the heat store fluid can be identical to the heat exchanger liquid, but this does not have to be the case. It is thus conceivable, for example, that the high-temperature battery is thermally connected via a suitable heat exchanger to the heat store in such a manner that a heat transfer can be ensured between heat exchanger liquid and heat store fluid. However, according to other alternative embodiments, it is also possible that the heat exchanger liquid is guided from the high-temperature battery to the heat store and temporarily stored therein.

Due to the heat transfer by means of a heat exchanger liquid, the quantity of heat in the high-temperature battery can be stored in a comparatively small space. This also enables the design of smaller heat storage systems, which can be embodied in modular construction, for example. At the same time, the heat can also be transported via suitable pipelines sufficiently rapidly also over moderate distances (up to approximately 100 m). A spatial separation of high-temperature battery and heat store can therefore also be achieved. In particular, it is conceivable that a plurality of high-temperature batteries are connected to one heat store. This heat store can be provided at a safe distance from the high-temperature batteries.

An even greater spatial separation is possible in particular by the use of the low-temperature heat store, which has a thermal coupling to the heat store. In this case, for example, heat can be transported from the heat store over multiple kilometers to a location at which an increased demand for heat exists. This demand for heat can thus be met at a location spatially remote from the high-temperature battery. The heat storage system is thus shown to be particularly flexible, and also energy-efficient. The overall efficiency of the heat storage system can therefore be advantageously improved.

In addition, the heat transfer to the heat exchanger liquid enables careful operation of the high-temperature battery, since the storage cells only have to be subjected to slight temperature variations and therefore the average service life to be expected for the storage cells is advantageously improved. At the same time, it is thus to be expected that the susceptibility to maintenance will also be reduced.

In addition, due to the thermal interconnection of the low-temperature heat store with the heat store, in normal operation of the high-temperature battery, harmful temperature peaks can be prevented from occurring in the high-temperature battery. This is because, due to the heat dissipation from the heat store to the low-temperature heat store, a sufficient amount of heat can always be dissipated in the normal case that the heat store can be kept at an advantageous temperature level. The low-temperature heat store is thus used for the advantageous temperature control of the heat store and therefore indirectly for the temperature control of the high-temperature battery. Since the low-temperature heat store typically has a significantly greater heat capacity than the heat store or the heat store fluid itself, the temperature level in the heat store can thus be kept uniformly constant by a supervised controlled or regulated heat transfer between heat store and low-temperature heat store. The high-temperature battery can therefore also dispense with further heat exchangers, for example, which have to be used, for example, upon the occurrence of temperature peaks for increased heat dissipation.

On the other hand, the heat store itself also enables a sufficient amount of heat to be stored over individual operating intervals of the high-temperature battery to also supply it with a sufficient amount of heat after several hours so that a suitable operating temperature can be maintained.

The heat store can also fulfill the task of an expansion vessel, as will be explained in greater detail hereafter, whereby the formation of a closed heat fluid conduction system is also enabled.

According to the invention, the thermal coupling of two stores (heat store and low-temperature heat store) thus simultaneously enables advantageous temperature control of the high-temperature battery at a high temperature level and simultaneous use of the waste heat in a low-temperature range.

According to a first particular embodiment of the heat storage system, it is provided that the heat exchanger liquid is stockpiled in a closed heat fluid conduction system, which is sealed off against the surroundings with respect to a fluid exchange. According to the embodiment, the heat fluid conduction system also comprises, in addition to the required lines, the storage containers and containers for stockpiling the fluid or fluids. In this regard, the heat store can also be part of the heat fluid conduction system. The heat fluid conduction system has a joint fluid guide, however, i.e., only one heat fluid for heat conduction is located in the heat fluid conduction system. A closed heat fluid guide enables the formation of a particularly performance-efficient system. In addition, such systems are distinguished by comparatively low exergetic heat losses, wherein also few hazardous materials or toxic materials are additionally released into the environment. A more strongly environmentally-compatible storage system can thus be provided in particular if thermal oils or heavy oils are used as the heat exchanger liquid. Furthermore, closed heat fluid conduction systems are less susceptible to mechanical effects from the outside, in particular with regard to coupling in vibrations, than open systems.

According to a further embodiment of the heat storage system, it is provided that the heat exchanger liquid and the heat store fluid are identical and are advantageously located in a heat fluid conduction system. According to the embodiment, heat exchanger losses between the heat exchanger liquid and the heat store fluid can thus be avoided. In addition, such a system has shown to be particularly efficient in heat dissipation and therefore in preventing temperature peaks during the operation of the high-temperature battery.

A further advantageous aspect of an embodiment of the heat storage system is that the heat store has an electrical heating device, which is designed to transfer heat to the heat store fluid during operation. According to the embodiment, equipping the high-temperature battery itself with a heating device can thus be omitted, which can, among other things, mean increased construction expenditure or temperature management. Rather, it is sufficient according to the embodiment to transfer the heat from the heated heat store fluid to the heat exchanger liquid, to thus supply the storage cells of the high-temperature battery with a sufficient amount of heat. Above all during standby operation to maintain a minimum operating temperature or in startup operation, during which a larger amount of heat has to be supplied to the high-temperature battery, such an embodiment is suitable. This embodiment is particularly energetically advantageous if multiple high-temperature batteries are interconnected with one heat store, so that a plurality of high-temperature batteries can be supplied with sufficient heat via one central heat source, the heat store.

According to a further advantageous embodiment of the invention, it is provided that the heat store has a compensation vessel, which is fluidically interconnected with the heat store and which, during operation of the high-temperature battery, comprises heat store fluid at a lower temperature level than in the heat store itself. The compensation vessel is used in particular for a volume compensation in the event of temperature variations. However, since the compensation vessel has heat store fluid which has a lower heat content than the heat store fluid in the heat store, lower exergetic heat losses are to be feared. Since the heat store fluid in the compensation vessel largely does not participate in the heat exchange between heat store fluid and heat exchanger liquid, however, the content thereof also does not have to be kept exactly at the operating temperature level of the heat store fluid. Such a heat storage system is thus to be evaluated as particularly advantageous exergetically. In addition, a substantially reduced temperature level of the compensation vessel has the advantage that the speed of chemical reactions of the heat store fluid with atmospheric oxygen is generally negligible and the usage duration of the heat store fluid is therefore not substantially restricted. Because of this fact, the necessity is usually also dispensed with of overlaying the heat store fluid with inert gas.

According to a refining embodiment, which is also advantageous, of the invention, it is provided that the heat store comprises a compensation vessel which is fluidically interconnected with the heat store, is integrated inside the high-temperature battery, and is sealed off against ambient air. To compensate for the thermal expansion of the heat store fluid which takes place when establishing the operational readiness of the high-temperature battery, the compensation vessel according to the embodiment can advantageously be integrated in at least one of the walls of the high-temperature battery or in the internal volume region thereof and can be embodied in the form of at least one metal bellows.

According to an embodiment of the invention, which is provided alternatively thereto and is also advantageous, it is provided that the heat store comprises a compensation vessel, which is fluidically interconnected with the heat store, is integrated outside the high-temperature battery, and is sealed off against ambient air. To compensate for the thermal expansion of the heat store fluid which takes place when establishing the operational readiness of the high-temperature battery, the compensation vessel can advantageously be embodied in the form of at least one metal bellows, which is arranged in spatial proximity to the high-temperature battery and/or the heat store. Spatial proximity relates in this case to an arrangement at a distance which is not greater than a distance which corresponds to the largest dimension of the high-temperature battery or the heat store in an arbitrary spatial direction.

According to a further advantageous embodiment of the heat storage system, the low-temperature heat store is designed as a water store and the low-temperature heat is stockpiled in the water of this water store. On the one hand, water is suitable as a cost-effective raw material, particularly for heat storage and, on the other hand, it can also be integrated easily in many heat circuits, which operate based on water, in the industrial and household fields of application. In particular, for example, the water from the water store can also be introduced into a remote heat network. The water is also suitable as prepared service water for household and industrial applications.

According to a further embodiment of the invention, it is provided that the high-temperature battery is housed together with the heat store in a transportable module, which has a suitable connection region for connecting a heat line for a low-temperature heat store. According to the embodiment, a plurality of modules can be thermally interconnected with one another, or can each be thermally coupled to a low-temperature heat store, to supply it with sufficient quantities of heat from thermal energy. The modularity enables in this case simple handling and maintenance, without having to take influence on the direct thermal interconnection of the high-temperature battery. According to the embodiment, a heat storage system is also easily scalable, for example, by simply thermally interconnecting multiple transportable modules. The heat management between high-temperature battery, heat exchanger liquid, heat store, and heat store fluid can be assumed by a suitable, fluidic circuit, which can also be comprised by the module. In this regard, the module can also have suitable interfaces, via which such a circuit communicates electrically with the outside.

According to a further embodiment, such a module, as described above, can also be provided with a suitable power and/or heat meter. Accordingly, the control or regulation of the module can also be performed in a power-controlled or heat-controlled manner.

It is to be noted at this point that the module is already to be considered to be transportable if it can be moved and arranged in a controlled manner with the aid of mechanical, electrical, or hydraulic devices. However, a module size which enables the module to be moved in a suitable and controlled manner solely by human force is particularly advantageous.

According to a first particular embodiment of the method according to the invention, it is provided that the step of transferring at least a part of the heat to the low-temperature heat store is performed as a function of the temperature level in the heat store. For this purpose, the heat store can typically have at least one temperature sensor, which detects the temperature in the heat store. The detected temperature values can subsequently be used to set the heat exchange between heat store and low-temperature heat store by means of a suitable control circuit or regulating circuit. In particular, the two can be connected by at least one heat exchanger.

According to the embodiment, heat store and low-temperature heat store can also be connected to one another via a heat line, wherein the conduction fluid guided in this heat line can also be transferred by pumping by means of at least one flow generator in the heat line. The transfer rate determines the desired heat transfer rate in this case. This can be set, for example, as a function of the temperature level in the heat store. To advantageously set the heat transfer rate, suitable temperature and/or pressure sensors can also be provided in the heat line. The low-temperature heat store typically also has at least one temperature sensor, to also be able to determine the heat content in the low-temperature heat store. According to the embodiment, by setting a suitable heat flow between heat store and low-temperature heat store, enough heat can always be withdrawn from the heat store so that it can be operated in an advantageous temperature level range. This temperature range advantageously does not vary by more than 20° C., this temperature range very particularly advantageously does not vary by more than 10° C.

Alternatively or also additionally, the step of transferring at least a part of this heat to the low-temperature heat store can be performed as a function of the temperature level in the high-temperature battery. As already stated on the preceding embodiment, thus, for example, in the present embodiment, the transfer rate in the heat line between heat store and low-temperature heat store can thus be set, for example, as a function of the temperature level in the high-temperature battery. For this purpose, the high-temperature battery has, for example, at least one or multiple temperature sensors and/or pressure sensors. Furthermore, the heat exchange between the high-temperature battery and the heat store can also be set in a manner which is regulated or controlled in a similar manner, so that a targeted temperature setting of the high-temperature battery during operation can be performed.

According to a further embodiment of the method according to the invention, it is provided that the step of transferring at least a part of the heat of the high-temperature battery to the heat exchanger liquid and/or the step of transferring at least a part of the heat in the heat store to the low-temperature heat store is performed in a regulated and/or controlled manner such that the temperature level of the heat exchanger liquid during proper operation of the high-temperature battery is within a temperature range having a breadth of at most 20° C., advantageously at most 10° C. Accordingly, the storage cells of the high-temperature battery can be protected from excessively strong temperature variations during operation, whereby the service life thereof is positively influenced. In particular, damage to storage cells by temperature stresses can advantageously be avoided.

The invention will be described in greater detail hereafter on the basis of individual figures. It is to be noted in this case that the figures illustrated hereafter are only to be understood as schematic. Restrictions with regard to the implementability do not result from such schematic embodiments.

Technical features having identical reference signs are to be distinguished hereafter in that they have identical technical functions or identical technical effects.

The technical features illustrated in the following figures are to be claimed alone, and also in any arbitrary combination with other technical features, if the combination resulting therefrom is suitable for achieving the technical objects on which the invention is based.

### BRIEF DESCRIPTION OF THE DRAWINGS

In the figures:

FIG. 1 shows a first embodiment of the heat storage system 1 according to the invention in a schematic circuit diagram;

FIG. 2 shows a further embodiment of the heat storage system 1 according to the invention according to a schematic circuit diagram;

FIG. 3 shows a flow chart of an embodiment of the method according to the invention.

### DETAILED DESCRIPTION OF INVENTION

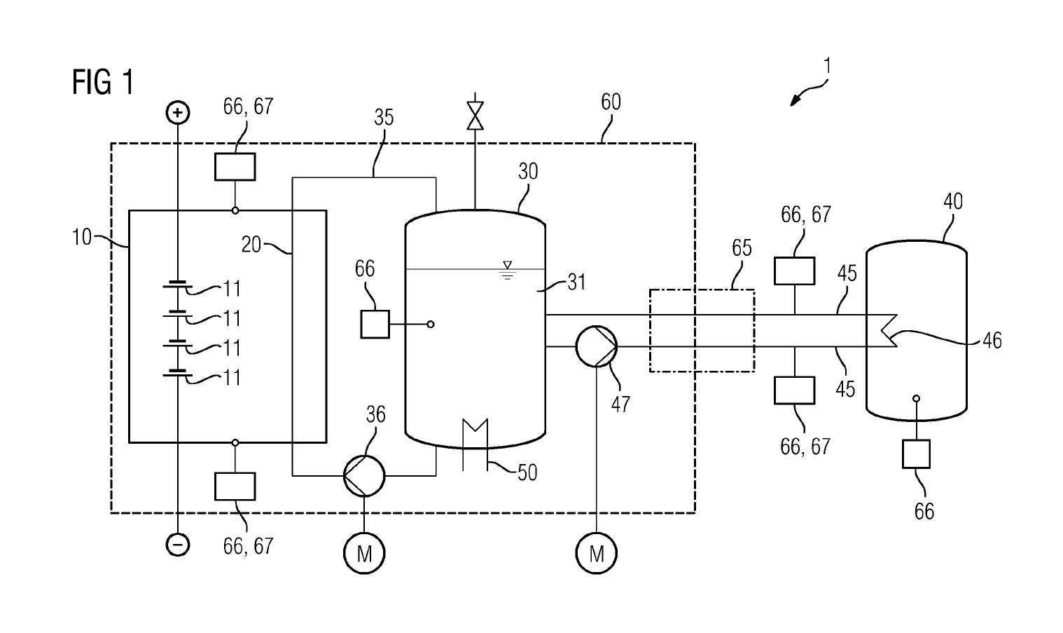

FIG. 1 shows a first embodiment of a heat storage system 1 according to the invention which has, in addition to a high-temperature battery 10 having a plurality of storage cells 11, a heat store 30. The high-temperature battery 10 can be electrically interconnected from the outside via electrical contacts (+, −) which are not provided with further reference signs. The storage cells 11 comprised by the high-temperature battery 10 are predominantly electrically interconnected with one another in series. To suitably detect the operating state of the high-temperature battery 10, suitable temperature sensors 66 and/or pressure sensors 67 are provided on or in the high-temperature battery 10.

In order that the high-temperature battery 10 can be supplied with heat or heat can be dissipated therefrom, a heat fluid conduction system 35 is comprised, which is thermally and/or fluidically interconnected with the high-temperature battery 10. The heat fluid conduction system 35 is suitable for transferring heat from the heat exchanger liquid 20, which surrounds the storage cells 11, to a heat store fluid 31. According to the embodiment, the heat exchanger liquid 20 can be identical to the heat store fluid 31, but this does not have to be the case. The heat store fluid 31 is in turn stockpiled in the heat store 30, wherein the heat store 30 has a suitable thermal interconnection with a heat line 45 for heat dissipation, the heat line being designed to transfer heat to a low-temperature heat store 40. Alternatively thereto, the thermal interconnection could also be embodied such that the heat line 45 is supplied to an external heat exchanger (not shown in the present case), so that energy which is not to be used further, for example, can be fed to the surroundings.

High-temperature battery 10 and also heat store 30 and heat fluid conduction system 35 are comprised by a module 60. The module 60 can be transportable in this case, or also not. To supply the high-temperature battery 10 with heat suitably during operation, heat is taken from the heat store 30 and transferred to the heat exchanger liquid 20 surrounding the storage cells 11. The high-temperature battery 10 can thus be brought to a suitable operating temperature level by the thermal contact between heat exchanger liquid 20 and the storage cells 11. If the temperature level of the heat store fluid 31 should not be sufficient in this case, an electrical heating device is additionally integrated in the heat store 30, which converts electrical energy into thermal energy and can transfer it to the heat store fluid 31. To always be informed about the heat content of the heat store fluid 31 located in the heat store 30, the heat store 30 is provided with a temperature sensor 66. To furthermore be able to set the quantity of heat exchanged between heat store 30 and high-temperature battery 10 suitably, the heat fluid conduction system 35 comprises a flow generator 36, which influences the flow speed.

According to the embodiment, the module 60 has a connection region 65, which is designed to connect a heat line 45 for thermal coupling to a low-temperature heat store 40. Further electrical or electronic interfaces can also be comprised by the module 60, which are not shown in the present case, however. The heat line 45 in turn has suitable temperature sensors 66 and/or pressure sensors 67, to be able to determine the quantity of heat exchanged between the heat store 30 and the low-temperature heat store 40 suitably. The heat line 45 has, for the heat exchange with the low-temperature heat store 40, a heat exchanger 46, which enables a temperature coupling to be formed on the side of the low-temperature heat store 40.

The heat conduction medium (not provided with reference signs in the present case) located in the heat line 45 can be, but does not have to be, identical in this case to the low-temperature heat store medium located in the low-temperature heat store 40. According to the embodiment, it is possible, for example, that the heat conduction medium is identical to water, which can also be stockpiled in the low-temperature heat store 40. In this case, a heat exchanger is typically also to be provided on the side of the heat store, wherein the heat line is designed as pressure resistant as a whole. The advantage of such an arrangement would be, for example, environmental aspects, since in case of damage to the heat line, no harmful substances could reach the environment. Alternatively, however, another heat conduction medium can also be provided in the heat line 45. The heat exchange between the heat store 30 and the low-temperature heat store 40 can be set suitably in this case with respect to the heat exchange rate, for example, in that a flow is applied by the flow generator 47 to the heat conduction medium located in the heat line 45. Depending on the speed of this flow, more or less heat can be exchanged between the heat store 30 and the low-temperature heat store 40.

According to the embodiment, it is also possible that the heat conduction medium located in the heat line 45 is identical to the heat store fluid 31. In this regard, it is possible, for example, that the heat line 45 is embodied as open toward the heat store 30, so that the heat store fluid 31 is transferred in the heat line 45 by the flow generator 47. The transferred heat rate can be determined, for example, by the various temperature or pressure values, which are recorded by the numerous temperature sensors 66 or pressure sensors 67, respectively.

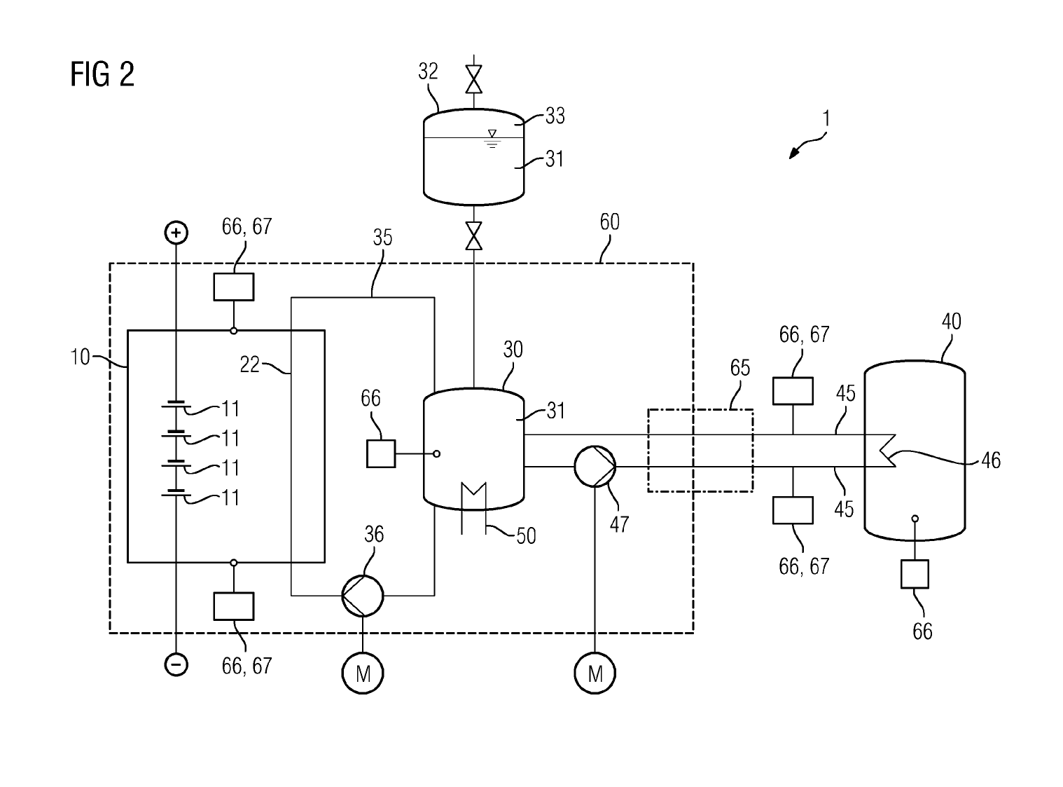

FIG. 2 shows a further embodiment of the heat storage system 1 according to the invention, which solely differs from the heat storage system 1 shown in FIG. 1 in that the heat store 30 is fluidically interconnected with a compensation vessel 32. If, according to the embodiment according to FIG. 1, the heat store 30, because of the incomplete filling with heat store fluid 31, is simultaneously also the compensation vessel, according to the embodiment according to FIG. 2, the heat store 30 is completely filled with heat store fluid 31. In the event of temperature variations during the operation of the high-temperature battery 10, however, a volume change of the heat store fluid 31 located in the heat store 30 occurs. To be able to compensate for these volume changes, for example, to avoid stress-related damage to the heat store 30, it is fluidically interconnected with the compensation vessel 32. In this case, the compensation vessel 32 also comprises heat store fluid 31, but is not completely filled with it, so that a part of the compensation vessel is occupied by air 33, for example. In the event of corresponding volume change of the heat store fluid 31 in the heat store 30, a suitable fluid exchange can be achieved between heat store 30 and compensation vessel 32. The heat store fluid 31 located in the compensation vessel 32 is advantageously at a lower temperature level than the heat store fluid 31 located in the heat store 30. Accordingly, as already stated above, an unnecessary heat loss due to the compensation vessel 32 or undesired chemical reactions of the heat store fluid with oxygen can be avoided. In the present case, according to the embodiment, the compensation vessel 32 is not also comprised by the module 60, but can also be comprised by it according to an alternative embodiment.

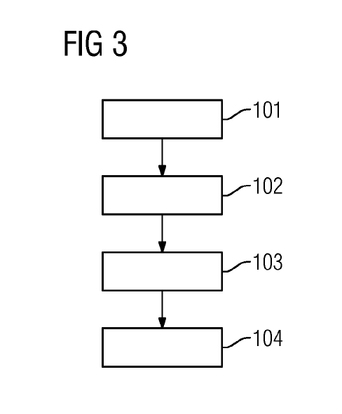

FIG. 3 shows a flow chart of a particular embodiment of the method according to the invention for operating a heat storage system 1, as described above. In this case, it comprises the following steps: —operating the high-temperature battery 10 while generating heat (first method step 101); —transferring at least a part of this heat to the heat exchanger liquid 20 (second method step 102); —storing at least a part of this heat by means of a heat store fluid 31 in a heat store 30 (third method step 103); —transferring at least a part of this heat to the low-temperature heat store 40 (fourth method step 104).

The two-stage interconnection described in the above embodiments between high-temperature battery 10 and heat store 30, on the one hand, and between heat store 30 and low-temperature heat store 40, on the other hand, can be altered by further downstream or further interposed heat stages. However, it is essential to the invention that, in a first heat stage, the high-temperature battery 10 can both be supplied with heat, and also heat can be dissipated therefrom. In a second downstream heat stage, heat can be withdrawn from the heat store 30 for a suitable heat usage and supplied to a low-temperature heat store 40. The supply of the heat to the low-temperature heat store 40 is to be performed in this case so that the quantity of heat taken from the high-temperature battery 10 ensures that the high-temperature battery 10 can always be operated at suitable temperatures. This relates in particular to the operation during heat dissipation from the high-temperature battery 10, for example, as occurs during the discharge of a technology based on the technology of the sodium-nickel-chloride cells. Depending on the size and operating mode of the high-temperature battery 10, approximately 150 to 250 Wₜₕ can be dissipated from the high-temperature battery 10 per 1000 Wₑₗ of discharged electrical power for further use.

Further embodiments result from the dependent claims.

1. A heat storage system comprising
a high-temperature battery having a plurality of storage cells, which have an operating temperature of at least 100° C., and which are in contact with a heat exchanger liquid for heat supply and dissipation,
a first heat store having a heat store fluid, which is thermally interconnected with the high-temperature battery such that heat can be transferred from the high-temperature battery to the heat store fluid, and
wherein the heat store is itself thermally interconnected with a low-temperature heat store for heat transfer, which is provided for storing low-temperature heat at a temperature level of at least 40° C.

2. The heat storage system as claimed in claim 1,
wherein the heat exchanger liquid is stockpiled in a closed heat fluid conduction system, which is sealed off against the surroundings with respect to a fluid exchange.

3. The heat storage system as claimed in claim 1,
wherein the heat exchanger liquid and the heat store fluid are identical.

4. The heat storage system as claimed in claim 1,
wherein the heat store has an electrical heating device, which is designed to transfer heat to the heat store fluid during operation.

5. The heat storage system as claimed in claim 1,
wherein the heat store has a compensation vessel, which is fluidically interconnected with the heat store, and which, during operation of the high-temperature battery, comprises heat store fluid at a lower temperature level than in the heat store itself.

6. The heat storage system as claimed in claim 1,
wherein the low-temperature heat store is designed as a water store and the low-temperature heat is stockpiled in water.

7. The heat storage system as claimed in claim 1,
wherein the high-temperature battery is housed together with the heat store in a transportable module, which has a suitable connection region for connecting a heat line for a low-temperature heat store.

8. A method for operating a heat storage system as claimed in claim 1, the method comprising:
operating the high-temperature battery while generating heat;
transferring at least a part of this heat to the heat exchanger liquid;
storing at least a part of this heat by means of a heat store fluid in a heat store; and
transferring at least a part of this heat to the low-temperature heat store.

9. The method as claimed in claim 8,
wherein the step of transferring at least a part of this heat to the low-temperature heat store is performed as a function of the temperature level in the heat store.

10. The method as claimed in claim 8,
wherein the step of transferring at least a part of this heat to the low-temperature heat store is performed as a function of the temperature level in the high-temperature battery.

11. The method as claimed in claim 8,
wherein the step of transferring at least a part of the heat of the high-temperature battery to the heat exchanger liquid and/or the step of transferring at least a part of the heat in the heat store to the low-temperature heat store is performed in a regulated and/or controlled manner such that the temperature level of the heat exchanger liquid during proper operation of the high-temperature battery is within a temperature range having a breadth of at most 20° C.

12. The heat storage system as claimed in claim 3,
wherein the heat exchanger liquid and the heat store fluid are located in a heat fluid conduction system.

13. The method as claims in claim 11,
wherein the temperature range has a breadth of at most 10° C.
